(19) United States
(12) Patent Application Publication
(10) Pub. No.: US 2026/0359377 A1
(43) Pub. Date: Nov. 12, 2026

(54) SYSTEM AND METHOD FOR DYNAMIC SEARCH ENGINE OPTIMIZATION SCORE BOOSTING USING AN AUTOMATED ARTIFICIAL INTELLIGENCE POWERED AND AGENT CENTRIC FRAMEWORK

(71) Applicant: Salesforce, Inc., San Francisco, CA (US)

(72) Inventors: Nikhil KAPRE, Bangalore (IN); Tarundeep BATRA, San Francisco, CA (US); Jayakrishnan Radhakrishna PILLAI, Bangalore (IN)

(73) Assignee: Salesforce, Inc., San Francisco, CA (US)

(21) Appl. No.: 19/204,181

(22) Filed: May 9, 2025

(51) Int. Cl. G06F 16/958

(52) U.S. Cl. CPC G06F 16/958

(57) ABSTRACT

Disclosed herein are system, method, and computer program product aspects for dynamically elevating a SEO score of a page based on an automated artificial intelligence powered and agent centric framework. An example embodiment identifies a first section of the webpage and a second section of the webpage based on a layout of a webpage. The embodiment generates a plurality of keywords for the second section of the webpage using an artificial intelligence (AI) agent based on an instruction and business information about a topic of the webpage. The embodiment identifies a subset of the plurality of keywords that are relevant to the business information. The embodiment aligns the subset of the plurality of keywords to the topic of the webpage. The embodiment then inserts the subset of the plurality of keywords into the first section of the webpage.

### BACKGROUND

Web pages lacking search engine optimization (SEO) face challenges in visibility, traffic, and user engagement. Without proper optimization, such pages fail to rank well on search engine results pages, making them virtually invisible to users searching for relevant content. This lack of visibility directly impacts organic traffic, reducing the number of potential leads and conversions. Additionally, poorly optimized pages often lack structured metadata, relevant keywords, and quality content, which search engines prioritize when determining rankings. These pages are perceived as less credible and trustworthy by both users and search engines. A lack of SEO can further lead to poor user experience due to slow loading times, unresponsive design, or irrelevant content. This drives away visitors and diminishes brand reputation. In a competitive digital landscape, failing to invest in SEO leaves businesses at a disadvantage, unable to reach their target audience effectively or achieve sustainable growth.

### BRIEF DESCRIPTION OF THE FIGURES

The accompanying drawings are incorporated herein and form a part of the specification.

FIG. 1 is a block diagram illustrating a SEO elevate system, according to aspects of the present disclosure.

FIG. 2 is a block diagram illustrating a generation agent platform of a SEO elevate system, according to aspects of the present disclosure.

FIG. 3 is a block diagram illustrating a SEO elevate processing engine of a SEO elevate system, according to aspects of the present disclosure.

FIG. 4 is a block diagram illustrating a cloud service and database of a SEO elevate system, according to aspects of the present disclosure.

FIG. 5 is a block diagram illustrating a measurement component of a SEO elevate processing engine, according to aspects of the present disclosure.

FIG. 6 is a block diagram illustrating a SEO elevate action of a SEO elevate processing engine, according to aspects of the present disclosure.

FIG. 7 is a block diagram illustrating a page analysis utility of a SEO elevate processing engine, according to aspects of the present disclosure.

FIG. 8 is a block diagram illustrating a SEO mapper utility of a SEO elevate processing engine, according to aspects of the present disclosure.

FIG. 9 is a block diagram illustrating a web page reader and adapter of a SEO elevate processing engine, according to aspects of the present disclosure.

FIG. 10 is a block diagram illustrating an operational framework of a SEO elevate system, according to aspects of the present disclosure.

FIG. 11 is an example illustrating a standard HTML page, according to aspects of the present disclosure.

FIG. 12 is a flowchart illustrating a method for dynamically elevating a SEO score for a page, according to aspects of the present disclosure.

FIG. 13 illustrates an example computer system useful for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof, for dynamically elevating a SEO score of a page using an automated artificial intelligence powered and agent centric framework.

An SEO score is a metric that indicates how well a website or page is optimized for search engines. If a web page's content is rich, but poor for web page's sections that search engines and page analytics application programming interface (API) providers read to compute SEO score, then a page's SEO score is needlessly degraded. The content may not be optimized with relevant keywords that users are searching for, leading to SEO score getting degraded. Content found to be duplicated across multiple pages or other websites, may lead to search engines penalizing the website. Lack of important SEO elements like title tags, metadata descriptions, and header tags can lead to the SEO score going down. Further non-relevant and outdated content can also penalize the SEO scores.

Current technical challenges that lead to a degradation or negative impact of the SEO score of a page or website may include, but are not limited to, technical SEO issues such as slow page load times, broken links, or poor mobile experience, confusing website layouts, inadequate internal linking for understanding page structure, lack of high-quality backlinks from reputable sites, lack of engagement on social media platforms, and/or non-usage of structured data (e.g., schema markup that provides search engines with explicit clues about the meaning of a page's content).

To tackle the technical challenges noted above, the embodiments disclosed herein provide a SEO elevate system, the SEO elevate system coordinates multiple components, including but not limited to, a web page reader and adapter, a page analysis utility, a content generator, a SEO measurement component, and/or a SEO attributer mapper, to dynamically boost SEO scoring for pages based on their content. The boosting of the SEO score include two aspects in which the first aspect aims to create relevant content based on the business or topics of the page and the second aspect aims to populate the created relevant content to the SEO interest sections (which can be assigned a higher attention than the rest of the sections).

As for the first aspect, the SEO elevate system that leverages at least an agentic and/or a large language model (LLM) may predict unique keywords by dynamically analyzing at least search trends, user queries, or relevant topics associated with a page. The SEO elevate system may further refine and update (e.g., in a real-time manner) the existing content of the page based on the dynamically updated information of the page. The SEO elevate system may also dynamically analyze structures or layouts of other top-ranking pages (e.g., competitor pages) and identify any advantages of their page structure or layout. The SEO elevate system may then automatically adopt such advantages and interpret them into a strategy to enhance the search rankings of the page. In response to the strategy, the SEO elevate system may incorporate such strategy (e.g., by converting the strategy into one or more instructions) to guide the agentic system or LLM to further refine or update the content or keywords in a real-time manner. A combination of keyword research and predication, content generation and refinement, and competitor page analysis may be dynamically handled concurrently by the SEO elevate system using a central orchestration engine in which the engine may continuously optimize the content of the page based on vast datasets of text from the various sources. In some aspects, the SEO elevate system may also have a real-time monitoring that can dynamically track the ranking of the page by any search engines. If a degraded SEO performance has been detected, the SEO elevate system may promptly refine or update the content or keywords having been generated. As for the second aspect, the SEO elevate system may also populate or assign the created relevant content or keywords associated with the page to the SEO interest sections of the page in a real-time manner, primarily streamlining the update process and improving efficiency. In some aspects, the SEO elevate system may at least automatically interpret natural language commands (e.g., eliminating the need for manual coding or operation for every update), identify relevant elements on the page (e.g., shifting the attention of the SEO elevation from business sections to SEO interest sections), and apply the changes (e.g., with adequate keywords) on the page directly.

The web page reader and adapter is a component to read pages and make sure the page data having been loaded in a specific format. The web page reader and adapter may enhance web page accessibility and usability, including addressing slow load times, broken links, and poor mobile experiences. In some aspects, for addressing slow page load time, the web page reader and adapter can leverage caching mechanisms to store frequently accessed content locally, reducing the need to re-download the same data repeatedly. The web page reader and adapter can also prioritize rendering essential content first, allowing user devices to interact with the page more quickly and see the core information first. In addition, the web page reader and adapter can compress data before transmitting it to the user devices, reducing bandwidth usage and improving load times. In some aspects, for addressing broken lines, the web page reader and adapter can scan pages for broken links and inform the user devices to take any corrective actions. Some web page reader and adapters can also automatically repair or redirect broken links to the correct destination. In some aspects, for addressing poor mobile experience, the web page reader and adapter can adapt the layout and content of web pages to fit different screen sizes for different user devices. The web page reader and adapter can also provide simplified navigation menus and controls for mobile user devices, making the user devices easier to browse and interact with web pages. In addition, the web page reader and adapter can incorporate features like screen reader compatibility, adjustable font sizes, and high contrast modes to make web page for accessible to the mobile user devices.

The page analysis utility analyze the content extracted by the web page readers and subject it to specific analysis about presence or absence of the certain sections within these web pages. As of now the actual content of these web pages has not been analyzed. The purpose of the page analysis utility is to analyze the structure of the page with regards to its topic of business, navigability, consistent structure, and presence or absence of certain sections deemed important by search and SEO engines. In some aspects, for addressing confusing or poorly structured website layouts, the page analysis utility may analyze various aspects of a website, including but not limited to, page structure, navigation, content hierarchy, and user behavior, to pinpoint areas of confusion or poor usability. The page analysis utility may also reveal how users navigate a website by tracking user interaction and may further allow website owners to make informed decisions about redesigning or optimizing the website layouts, ensuring a more intuitive user interaction. In some aspects, for addressing inadequate internal linking of page structure, the page analysis utility may help search engines understand the relationships between related pages by adding internal links within the content that connect these related pages. The page analysis may also use keyword-rich and contextually relevant anchor text to help user devices and search engines to understand the purpose of the linked page. In addition, the page analysis may ensure that the most important pages are well-linked to from other relevant pages on the web site.

The content generator is a component that generates brand specific text for a certain section of the page; for example product description for a product page. In some aspects, for addressing a lack of high-quality backlinks from reputable sites, the content generator may create high-quality, valuable, and relevant content that naturally attracts links from other websites. In some aspects, for addressing a lack of engagement on social media platforms, the content generator can leverage an artificial intelligence (AI) system or model, for example, an LLM to create diverse, engaging content formats, personalize experiences, and analyze performance to optimize strategies. For example, the content generator with an installed or queried AI system can generate various content types, including but not limited to, text, images, videos, and audio, catering to different social media platforms. The content generator can also generate various interactive contents (e.g., in a real-time manner), including but not limited to, quizzes, polls, engaging social media campaigns, contests with rewards, and other interactive elements to encourage user participation and real-time engagement. In some aspects, for addressing the non-usage of structured data, the content generator (with the AI system) may create schema markups that are most appropriate for the website's content. For example, once the content is generated, the content generator may further create a list of top keywords (which can be a part of the schema markup) to enrich information in sections for a greater SEO boost.

The SEO measurement component is a component that generates SEO scores using different engines. The SEO measurement component are developed for each of the supported SEO engines. Once the SEO measurement routines are run, the analysis of the page is available in terms of the actions to take and the overall SEO score of the page. In some aspects, the SEO measurement component can analyze engagement metrics, including but not limited to, comments, shares, etc. to identify what content performs best and optimize future strategies. By monitoring or analyzing the engagement metrics, the SEO measurement component can identify relevant keywords and hashtags to improve content visibility and reach. For example, during the monitoring process, the SEO measurement component can facilitate an A/B testing of varying content formats and strategies to determine what resonates best (e.g., achieving the highest engagement metric) with the user. The SEO measurement component can also track social media trends and emerging topics to ensure content remains relevant and engaging (e.g., based on the monitored engagement metrics). In some aspects, for addressing a lack of high-quality backlinks from reputable sites, the SEO measurement component may also conduct the A/B testing to identify any low-quality links in the backlink profile.

The SEO attribute mapper is a component that maps the content from business sections of the page to the SEO interest sections. As of this writing this mapper, basically the SEO attribute mapper picks the words that should be copied over to the SEO interest sections. The SEO attribute mapper can address the non-usage of structured data by implementing the correct schema markup for website content. Implementing with the correct schema markup may enable search engines to better understand and categorize page information, potentially leading to richer search results and an improved SEO performance. In some aspects, the SEO attribute mapper can map the correct schema attributes to the relevant elements on pages (e.g., SEO interest sections) and add the correct schema markup code to implement on the pages. In some aspects, the SEO attribute mapper may identify the hypertext markup language (HTML) elements on the page that contain the information corresponding to the schema attributes, for example, <title> for title tags, <meta name=“description”> for meta description, <h1> to <h6> for header tags, <img> for image, etc. The SEO attribute mapper may then use JSON-LD, Microdata, RDFa, and/or any other tools that would be appreciated by a person with ordinary skills in the art to add the schema markup to the HTML elements in the page. As such, the relevant elements on pages (SEO interest sections) can be optimally filled with the correct schema attributes with optimal character length (e.g., can be of maximum length). In addition, the page load speeds can be optimized and not penalized due to data filled up in the relevant elements on pages.

In summary, this disclosure is directed to a SEO elevate system for dynamically elevating a SEO score of a page. With the help of the SEO elevate system, end users can boost a SEO score of a page based on their area of expertise and their business in which the SEO optimization is automatically performed by the SEO elevate system. The SEO elevate system addresses current technical challenges (e.g., that may lead to a degradation or negative impact of the SEO score of a page) based on a coordination between at least the web page reader and adapter, the page analysis utility, the content generator, the SEO measurement component, and/or the SEO attributer mapper. As such, the SEO elevate system can automatically boost SEO scoring for both static and dynamic pages based on the business content of that pages without human interpretation. These and other aspects of the present disclosure will be described in further detail below with respect to the accompanying drawings.

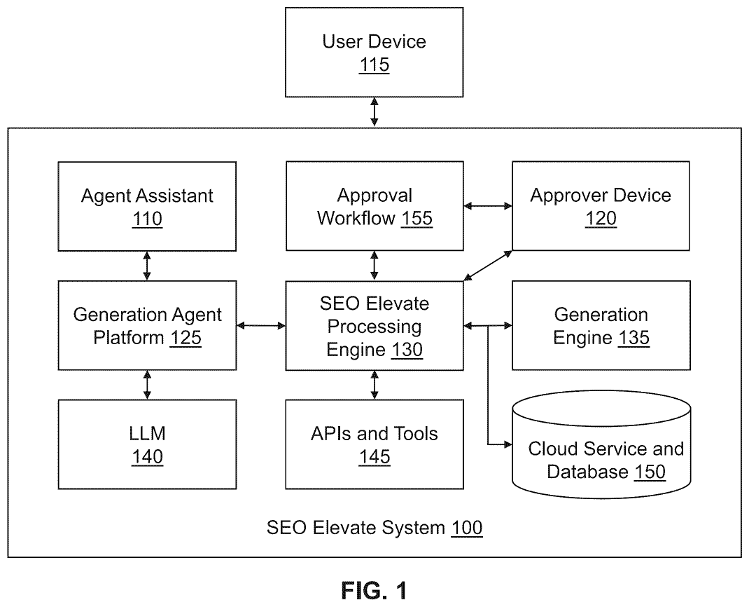

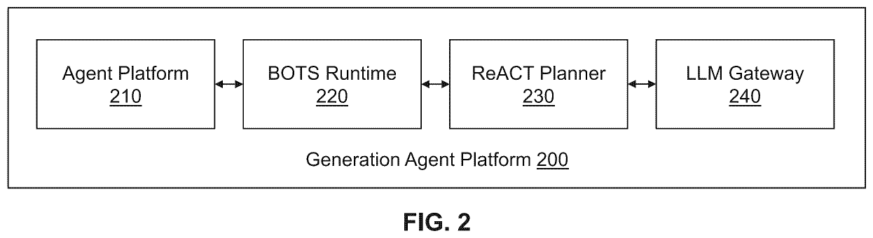

FIG. 1 is a block diagram illustrating a SEO elevate system 100, according to aspects of the present disclosure. In some aspects, SEO elevate system 100 may include, but is not limited to, an agent assistant 110, a generation agent platform 125, a SEO elevate processing engine 130, a generation engine 135, an LLM 140, APIs and tools 145, a cloud service and database 150, an approval workflow 155, and/or an approver device 120. The detailed system components of the SEO elevate system will be further explained in at least FIGS. 2-9.

Generation agent platform 125 may be configured to interface with agent assistant 110 (e.g., a browser for a user device 115) to open a remote takeover session on the endpoint or execute tasks on it, and it may allow generation agent platform 125 to connect to more than one user devices at the same time. In some aspects, a user devices 115 may be a separate computing platform including but not limited to smartphones, tablet computers, laptop computers, desktop computers, web browsers, and/or other computing devices, apparatuses, systems, or platforms. In some aspects, a user device 115 may transmit information to SEO elevate system 100 either in a wired or wireless manner and may be, for example, the Internet, a Local Area Network, or a Wide Area Network. The transmission may utilize a network protocol, such as, for example, a hypertext transfer protocol (HTTP), a transmission control protocol (TCP)/Internet protocol (IP) protocol, Ethernet, or an asynchronous transfer mode.

Generation agent platform 125 may be configured to interface with SEO elevate processing engine 130 to enhance page visibility and organize page traffic. In some aspects, generation agent platform 125 may be used to automate tasks that support SEO elevation, including but not limited to, keyword research, content creation, and link building. The agents of generation agent platform 125 can support various SEO elevate actions that can be used by the SEO elevate processing engine, including analyzing data, generating content, and/or optimizing website structure to improve search engine rankings. In some aspects, after defining SEO elevate actions, SEO elevate processing engine 130 may streamline the SEO elevation efforts, automate repetitive tasks, and further focus on strategic initiatives that may drive results with higher efficiency.

Generation agent platform 125 may also be configured to interface with an LLM 140 for implementing applications or agent actions for a range of generative tasks, including but not limited to, text or content generation, refinement, and/or optimization. In some aspects, LLM 140 may be queried by generation agent platform 125 via an LLM gateway which is a centralized orchestration platform that improves the deployment and management of one or more LLMs in production environments. The LLM gateway may abstract the complexities of working directly with individual models, offering a unified interface to connect applications with the one or more LLMs (e.g., an LLM 140).

SEO elevate processing engine 130 may be configured to interface with a generation engine 135 (e.g., an agentic system or a generative AI-based system) to generate content (e.g., keywords) that may be useful for SEO elevation. In some aspects, content generation is the process of creating digital media like text, images, videos, and audio to be deployed on the internet or other channels, aiming to engage audiences through compelling and relevant content. During the content generation, generation engine 135 can generate content for a user specified topic with any instructions. The generated content can also cover multiple output formats or modalities, including but not limited to, text, image, video and/or audio. In some aspects, generation engine 135 may refine the created content to align with a specific business information or brand guidelines of an enterprise. During the content refinement, generation engine 135 can define how the generation process should behave and what resources (e.g., knowledge base, business information, brand guidelines, etc.) the generation may use, ensuring that generated content can align with specific business information.

In some aspects, generation engine 135 can generate content that adheres to specific business information using retrieval-augmented generation (RAG) that integrates the business information as part of the knowledge base. The RAG can ensure the generation engine performance by grounding responses in this business information. For example, when being queried, the AI or agentic systems can ground the responses using brand guidelines of an enterprise to generate content that reflects the brand identity. In some aspects, the content generation system can also fine-tune or train the AI or agentic systems using the knowledge base with the integrated business information.

SEO elevate processing engine 130 may be configured to interface with an approval workflow 155 to approve the content being generated. In some aspects, within the approval workflow, SEO elevate processing engine 130 may be configured to connect with an approver device 120 in which the approver device may be configured to consolidate any changes or suggestions to the generated content and ensure these changes or suggestions are incorporated into the content. In some aspects, approver device 120 may transmit information to SEO elevate processing engine 130 either in a wired or wireless manner and may be, for example, the Internet, a Local Area Network, or a Wide Area Network. The transmission may utilize a network protocol, such as, for example, a hypertext transfer protocol (HTTP), a transmission control protocol (TCP)/Internet protocol (IP) protocol, Ethernet, or an asynchronous transfer mode.

SEO elevate processing engine 130 may also be configured to interface with a cloud service and database 150 that stores or accesses files, data sources, and/or any information related to the SEO elevate processing. This cloud service and database may provide access to various sources, including but not limited to, databases, web pages, web services, internal or external files with different formats, and/or any other systems that hold data. SEO elevate processing engine 130 may use cloud service and database 150 to update a knowledge base for any content generation or other generative tasks. This process may involve storing the knowledge base content within a cloud-hosted database and updating it through the cloud service's interface or APIs.

In some aspects, cloud service and database 150 may support various data processing approaches or models, including but is not limited to, data cleaning, data extraction, file change detection, and/or data warehousing. For example, data cleaning may refer to a process of identifying and correcting or removing inaccurate, incomplete, or irrelevant data within a dataset to improve its quality and usability for analysis or decision-making. Data extraction may refer to a process of retrieving specific data from the platform for various purposes, including but not limited to, backups, reporting, and/or integrations. File change detection may refer to a process of publishing events for changes to records (e.g., create, update, delete, undelete). Data warehousing may refer to a process of leveraging a centralized repository to store and manage large amounts of data from various sources for any analysis and reporting purposes.

In addition, SEO elevate processing engine 130 may be configured to interface with APIs and tools 145 (e.g., by a third-party service) to integrate applications of the processing engine with any internal or external systems and platforms. These APIs or tools may expose functionalities and data to external user devices, expanding application capabilities and facilitating any application or API development, testing, monitoring, and management purposes.

FIG. 2 is a block diagram illustrating a generation agent platform 200 of a SEO elevate system 100, according to aspects of the present disclosure. In some aspects, generation agent platform 200 may include, but is not limited to, an agent platform 210, a BOTS runtime 220, ReACT planner 230, and/or an LLM gateway 240.

Agent platform 210 may provide tools and a platform for building and deploying autonomous AI agents or actions that can handle specific tasks and processes to augment human workers across various business functions. In some aspects, agent platform 210 may deploy various AI agents, including but not limited to, a service agent, a sales agent, a marking agent, a commerce agent, and/or a platform agent. The service agent may deflect incoming support cases by responding to customer inquiries. The sales agent may proactively contact customers, respond to their questions, and schedule meetings that may create any potential business. The marketing agent may generate briefs, audience segments, content, and customer journeys. The commerce agent may offer AI-powered shopping assistance on commerce sites or messaging apps. The platform agent may assist with various tasks across different departments.

In some aspects, these AI agents may be built on agent platform 210, based on existing APIs and tools. These AI agents can connect to any data source and use it in real-time to plan, reason, and evaluate. These AI agents can also leverage any workflow, automation, or API to complete tasks. These AI agents can operate autonomously (e.g., within a defined guideline to ensure accuracy and consistency), retrieving data on demand, building action plans, and executing them without human intervention. In some aspects, when building these AI agents, agent platform 210 may enable admin or developer devices to use natural language to create instructions and guidelines for their agents. Agent platform 210 may connect to at least enterprise data and security models to automate the operations. Agent platform 210 may also use a generative AI and an LLM to synthetize natural and human-like conversations.

BOTS runtime 220 may refer to an environment or infrastructure in which generation agent platform 200 may execute any chat bot applications (e.g., or some other AI applications or solutions). BOTS runtime 220 may support an automated interaction with the user devices and enable the chat bot applications to at least understand inputs (e.g., equations or requests) from the user devices, access and process data (e.g., user records, knowledge base, etc.) from generation agent platform 200, generate appropriate responses or take actions, and/or handle complex interactions and scenarios. In some aspects, BOTS runtime 220 may support a conversational flow or scripts to define how the chat bots may interact with the user devices and provide tools for integrating the chat bots into various communication channels such as web chat, mobile apps, etc.

ReACT planner 230 may be configured to interface with BOTS runtime 220 or a planner runtime (e.g., an environment in which the react planner application may execute) to schedule and plan actions. For example, ReACT planner 230 may be designed for scheduling and planning actions and applications. ReACT planner 230 may facilitate the creation of user interfaces for managing schedules, tasks, and events in which ReACT planner 230 may support features such as drag-and-drop functionality, customizable catalogs, and two-dimensional or three-dimensional visualization. In some aspects, interfaced with ReACT planner 230, the planner runtime may provide the necessary tools and resources for the components to render and interact with the user device.

LLM gateway 240 may be a centralized orchestration platform that improves the deployment and management of one or more LLMs in production environments. LLM gateway 240 may abstract the complexities of working directly with individual models, offering a unified interface to connect applications with the one or more LLMs.

In some aspects, LLM gateway 240 may be integrated into ReACT planner 230 to enable the creation of dynamic and intelligent user interfaces. This integration may allow for natural language processing capabilities (e.g., from the LLM queried via the LLM gateway) within ReACT applications, facilitating tasks, including but not limited to, task planning, code generation, and enhanced user experiences. For example, the LLM can be used to break down complex tasks into manageable steps. ReAct planner 230 may allow the LLM to generate reasoning traces and task-specific actions, which can be used to guide the user to decide on the best course of action through a process.

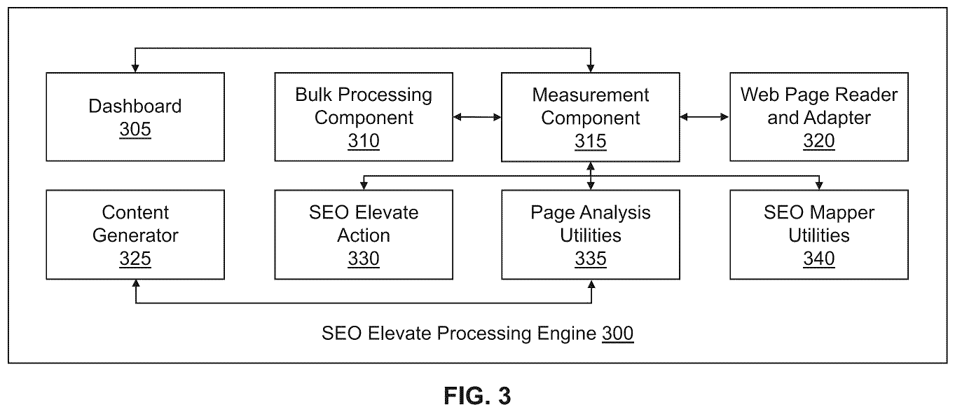

FIG. 3 is a block diagram illustrating a SEO elevate processing engine 300 of a SEO elevate system 100, according to aspects of the present disclosure. In some aspects, SEO elevate processing engine 300 may include, but is not limited to, a dashboard 305, a bulk processing component 310, a measurement component 315, a web page reader and adapter 320, a content generator 325, a SEO elevate action 330, a page analysis utility 335, and/or a SEO mapper utility 340.

Dashboard 305 (e.g., SEO dashboard) may refer to a tool, a system, or a user interface configured to consolidate various SEO metrics and data into a single, easy-to-understand view. Dashboard 305 may facilitate businesses or enterprise track their website's SEO performance (e.g., in a real-time manner) and identify areas for improvement. By visualizing key metrics like rankings, traffic, and backlinks, dashboard 305 provides quick insights into the effectiveness of SEO strategies. In some aspects, dashboard 305 can also be used to communicate SEO progress or strategies to user devices or client devices. The user devices may further add or modify the widgets and metrics visualized in dashboard 305 to the most relevant ones that reflect to the business and goals of the user devices (e.g., the enterprise).

Bulk processing component 310 may be configured to optimize multiple web pages or content pieces simultaneously for search engines elevation purposes. Bulk processing component 310 may use AI-powered tools, models, systems, or software to make large-scale SEO improvements efficiently, including but not limited to, optimizing title tags, meta descriptions, alt text, and/or internal linking across a batch of websites concurrently. This optimization may be performed through a bulk optimization in which multiple web pages can be optimized for a specific keyword at once. In some aspects, bulk processing component 310, even within a website, may also optimize the different areas of the website (e.g., title tags, meta descriptions, alt text, and/or internal linking) at once to ensure these areas can comply with the latest search engine standards.

Web page reader and adapter 320 may be configured to read pages and adapt the page data having been loaded in a specific format. Web page reader and adapter 320 may enhance web page accessibility and usability, including addressing slow load times, broken links, and poor mobile experiences. Web page reader and adapter 320 can leverage caching mechanisms to store frequently accessed content locally and then prioritize rendering essential content first. Web page reader and adapter 320 can also scan pages for broken links and inform the user devices to take any corrective actions, for example, the web page reader and adapter may adapt the layout and content of web pages to fit different screen sizes for different user devices. Web page reader and adapter 320 can also provide simplified navigation menus and controls for mobile user devices, making the user devices easier to browse and interact with web pages. Web page reader and adapter 320 can incorporate features, including but not limited to, screen reader compatibility, adjustable font sizes, and high contrast modes to make web page for accessible to the mobile user devices.

Page analysis utility 335 may be configured to analyze the content extracted by web page reader and adapter 320 and subject it to specific analysis about presence or absence of the certain sections within these web pages (e.g., the topic of business, navigability, consistent structure, etc.). In some aspects, page analysis utility 335 may also analyze various aspects of a website, including but not limited to, page structure, navigation, content hierarchy, and user behavior, to pinpoint areas of confusion or poor usability. Page analysis utility 335 may also reveal how users navigate a website by tracking user interaction and may further allow website owners to make informed decisions about redesigning or optimizing the website layouts.

In some aspects, page analysis utility 335 may be configured to interface with content generator 325 for any generative tasks. For example, page analysis utility 335 may collect data about a website's pages, such as keywords, content structure, user behavior, and SEO metrics, and then analyze this data to identify areas for improvement. Page analysis utility 335 may provide the data insights to the content generator. In some aspects, the content generator may then feed the newly generated content back to the page analysis utility (e.g., in an iterative way) for further analysis and refinement.

Content generator 325 may be configured to generate brand specific text (e.g., naturally attracting links from other websites) for a certain section of the page, for example product description for a product page. In some aspects, content generator 325 can leverage an AI system or model, for example, an LLM to create diverse and engaging content formats and relevant content that aligns with brand identity. For example, content generator 325 with an installed or queried AI system can generate various content types, including but not limited to, text, images, videos, and audio, catering to different social media platforms. Content generator 325 can generate various interactive contents (e.g., in a real-time manner), including but not limited to, quizzes, polls, engaging social media campaigns, contests with rewards, and other interactive elements to encourage user participation and real-time engagement. Content generator 325 (with the AI system) may also create schema markups that are most appropriate for the website's content and relevant to the brand identity. Once the content is generated, the content generator may further create a list of top keywords (which can be a part of the schema markup) to enrich information in sections for a greater SEO boost.

SEO elevate action 330 may refer to a process of optimizing a website for search engines to improve its visibility and ranking in search results. SEO elevate action 330 may involve a range of strategies and techniques to make content and pages more accessible and relevant to potential customers searching online. SEO elevate action 330 may also include, but is not limited to, pre-defined functionalities and/or actions (e.g., invocable actions) that can be triggered or executed to influence the website's SEO, including but not limited to, an action to update or optimize metadata, improve on-page content, and/or optimize the website structure.

SEO mapper utility 340 may be configured to organize and optimize website content by assigning specific keywords to relevant pages. This keyword assignment may improve search engine visibility and ensure that the right pages appear for or target the right search queries. In some aspects, SEO mapper utility 340 may help identify relevant keywords and analyze their search volume, competition, and trends. SEO mapper utility 340 may also create a keyword map for website structure and content in which the pages and keywords can be arranged in groups of keyword clusters to create a logical structure of the website based on the keywords.

Measurement component 315 may be configured to interface with dashboard 305, bulk processing component 310, web page reader and adapter 320, SEO elevate action 330, page analysis utility 335, and/or SEO mapper utility 340. Measurement component 315 may generate SEO scores using different engines or based on a collaboration between different components of SEO elevate processing engine 300. In particular, measurement component 315 may orchestrate the different components to perform any assigned tasks based on the user request. For example, bulk processing component 310 may be used to parallelize processing of multiple web pages in a batch in which web page reader and adapter 320 may be activated to read the web page information and adapt it into a suitable format for each of the parallel processing threads. Once the SEO measurement routines are run, the analysis of the page (e.g., performed by the analysis utility) is available in terms of the actions to take the overall SEO score of the page. In some aspects, measurement component 315 can analyze engagement metrics, including but not limited to, comments, shares, etc. to identify what content performs best and optimize future strategies. By monitoring or analyzing the engagement metrics, measurement component 315 can also identify relevant keywords and hashtags and then assign the keywords to different relevant pages (e.g., based on the SEO mapper utility) to improve content visibility and reach. In some aspects, measurement component 315 may also visualize key metrics, including but not limited to, rankings, traffic, and backlinks (e.g., based on the dashboard) to provide a comprehensive and real-time insight into the effectiveness of SEO strategies.

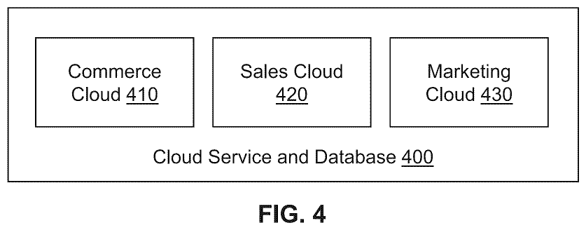

FIG. 4 is a block diagram illustrating a cloud service and database 400 of a SEO elevate system 100, according to aspects of the present disclosure. In some aspects, cloud service and database 400 may include, but is not limited to, a commerce cloud 410, a sales cloud 420, and/or a marketing cloud 430.

Commerce cloud 410 may refer to a cloud-based platform that helps businesses manage and grow their online business. Commerce cloud 410 may offer tools and features to support multiple stages of digital commerce, from product discovery to order delivery. In some aspects, commerce cloud 410 may leverage AI to offer features including product search and recommendation, which can suggest relevant products or help customers find what they're looking for. Sales cloud 420 may refer to a cloud-based platform, primarily a customer relationship management system, designed to help businesses manage their sales processes and grow revenue. Sales cloud 420 may also provide tools and technologies to aid sales teams (e.g., sales agent) in their daily work, such as opportunity management, forecasting, pipeline tracking, and sales automation. In some aspects, sales cloud 420 may leverage AI or LLM to at least analyze data and offer insights, predict sales outcomes, and/or personalize user interactions. Marketing cloud 430 may refer to a digital marketing automation and analytics platform that helps businesses manage and analyze marketing efforts across multiple channels. Marketing cloud 420 may allow for personalized customer experiences, data-driven marketing strategies, and the creation of effective and targeted marketing campaigns. In some aspects, the marketing cloud may also leverage AI to at least automate tasks, personalize experiences, and provide real-time predictive insights to at least help the marketer segment audiences, engage leads and customers, and/or design personalized marketing messages and campaigns across the entire customer lifecycle.

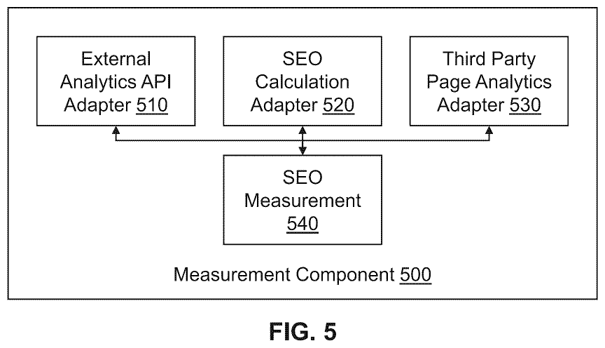

FIG. 5 is a block diagram illustrating a measurement component 500 of a SEO elevate processing engine 300, according to aspects of the present disclosure. In some aspects, measurement component 500 may include, but is not limited to, an external analytics API adapter 510, a SEO calculation adapter 520, a third-party page analytics adapter 530, and/or a SEO measurement 540.

SEO measurement 540 may be configured to interface with external analytics API adapter 510, SEO calculation adapter 520, and third-party page analytics adapter 530 to generate and measure SEO scores using different engines. Once SEO measurement routines are run, the analysis of the page may be available in terms of the actions to take and the overall SEO score of the page.

External analytics API adapter 510 may act as a bridge to allow for SEO elevate processing engine 300 to connect with and retrieve data from external analytics platforms or services. External analytics API adapter 510 may handle the specific API requests and responses required by the external platform or service, providing a simplified and user-friendly interface for interacting with its data. External analytics API adapter 510 may also handle the actual communication with any external analytics platform or service, including but not limited to, authentication, data formatting, and/or error handling.

SEO calculation adapter 520 may be developed for SEO elevate processing engine 300 as a tool or method that helps businesses measure and analyze the financial impact of their SEO efforts. SEO calculation adapter 520 may allow the SEO engine to under the return in investment (ROI) of their SEO activities (e.g., how much revenue is generated by organic search traffic in relation to the cost of their SEO investment). For example, SEO calculation adapter 520 may integrate data from various sources including website analytics and customer relationship management systems to gather relevant information for ROI calculations. SEO calculation adapter 520 may help track key performance indicators like organic traffic, conversion rates, and revenue generated from organic sources, providing a comprehensive view of SEO performance. In addition, SEO calculation adapter 520 may also create customized reports and dashboards that showcase key SEO metrics and ROI data.

Third-party page analytics adapter 530 may refer to a mechanism that allows SEO elevate processing engine 300 to send data (e.g., page views, unique visitors, etc.) from the web pages or application to a third-party analytics platform for tracking and analysis of user behavior, website traffic, and conversions. Third-party page analytics adapter 530 may also act as a bridge, connecting a specific website's data with a more powerful analytics tool than the built-in analytics tools of SEO elevate processing engine 300.

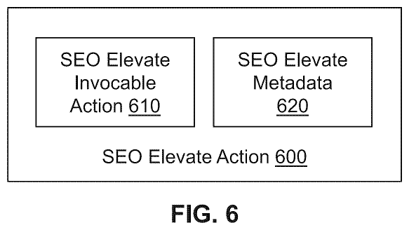

FIG. 6 is a block diagram illustrating a SEO elevate action 600 of a SEO elevate processing engine 300, according to aspects of the present disclosure. In some aspects, SEO elevate action 600 may include, but is not limited to, SEO elevate invocable action 610 and SEO elevate metadata 620. SEO elevate action 600 may refer to the process of optimizing a website for search engines to improve its visibility and ranking in search results. SEO elevate action 600 may involve a range of strategies and techniques to make content and pages more accessible and relevant to potential customers searching online.

SEO elevate invocable action 610 may refer to pre-defined functionalities or actions that can be triggered or executed to influence the website's SEO, including but not limited to, an action to update or optimize metadata, improve on-page content, and/or optimize the website structure. SEO elevate metadata 620 may refer to the process of optimizing metadata elements, including but not limited to, title tags, meta descriptions, and/or alt text to improve a website's SEO performance. For example, title tags may be the text that appears in the search result listing and may also be the title of the webpage. Meta descriptions may be a brief summary of the page's content that appears in the search results and helps users decide if the page is relevant to their query. Alt text may refer to alternative text for images that provides context and helps search engines understand the image. Other metadata or tags may also be used as the SEO elevate metadata that provides information about the webpage, such as the author information, publication date, and/or any keywords.

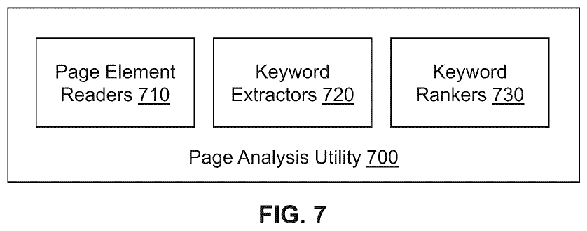

FIG. 7 is a block diagram illustrating a page analysis utility 700 of a SEO elevate processing engine 300, according to aspects of the present disclosure. In some aspects, page analysis utility 700 may include, but is not limited to, a page element reader 710, a keyword extractor 720, and/or a keyword ranker 730. Page analysis utility 700 may analyze the content and subject it to specific analysis about presence or absence of the certain sections within these web pages. In some aspects, page analysis utility 700 may analyze the structure of the page with regards to its topic of business, navigability, consistent structure, and presence or absence of certain sections deemed important by the search and/or SEO elevate processing engine 300.

Page element reader 710 may interpret the text, HTML elements, and visual cues on a screen of a website or page and present this information in an accessible format. Page element reader 710 may also interact with the underlying code of the digital content and extract information to present in a usable format. Keyword extractor 720 may include, but is not limited to, a tool or algorithm that can automatically identify and extract the most relevant words or phrases from a text. Keyword extractor 720 may use natural language processing (NLP) and machine learning (ML) techniques to analyze text and determine which keywords best represent the topic or content of the text. This extracted information can be used for various purposes, including but not limited to summarizing text, facilitating information retrieval, or improving content analysis. Keyword ranker 730 may refer to a tool or method used to track and monitor the position of a website or a page in search engine results for a specific keyword or phrase.

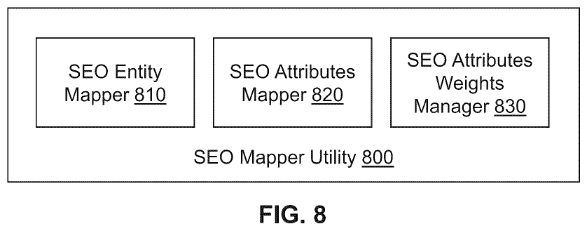

FIG. 8 is a block diagram illustrating a SEO mapper utility 800 of a SEO elevate processing engine 300, according to aspects of the present disclosure. In some aspects, SEO mapper utility 800 may include, but is not limited to, a SEO entity mapper 810, a SEO attribute mapper 820, and/or a SEO attribute weight manager 830. SEO mapper utility 800 may organize and optimize website content by assigning specific keywords to relevant pages. This keyword assignment may improve search engine visibility and ensure that the right pages appear for the right search queries.

SEO entity mapper 810 may identify and map out entities within a piece of content or on a website in which an entity (e.g., a singular, well-defined object or concept that can be identified and distinguished) may include, but are not limited to, uniquely identifiable items such as people, places, things, or concepts that are represented in the search engine. SEO entity mapper 810 may also support breaking down a topic or page into various entities and then identifying the relationships between them.

SEO attribute mapper 820 may connect specific keywords to relevant website pages or content. SEO attribute mapper 820 may assign keywords to content, ensuring each page targets the most appropriate search terms, improving search engine visibility, and facilitating creation of a more structured and logical website architecture. In some aspects, SEO attribute mapper 820 may be a component that maps the content from business sections of the page to the SEO interest sections. For example, SEO attribute mapper 820 may pick the words that should be copied over to the SEO interest sections.

SEO attribute weight manager 830 may determine how much importance different aspects of a website's content or product information (e.g., attributes) have on SEO efforts. SEO attribute weight manager 830 may prioritize which attributes are most crucial for improving rankings and visibility in search results. For example, content quality might be given a higher weight, meaning that creating high-quality, engaging content may be crucial for a SEO success. In some aspects, SEO attribute weight manager 830 may visualize (e.g., in a pie chart or any other plots) the relative importance or weight of different factors (e.g., content quality, on-page SEO, off-page SEO) that may contribute to the overall SEO scores.

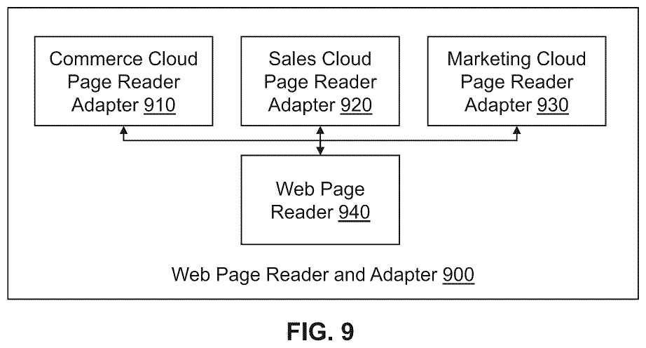

FIG. 9 is a block diagram illustrating a web page reader and adapter 900 of a SEO elevate processing engine 300, according to aspects of the present disclosure. In some aspects, web page reader and adapter 900 may include, but is not limited to, a commerce cloud page reader adapter 910, a sales cloud page reader adapter 920, a marketing cloud page reader adapter 930, and/or a web page reader 940. Web page reader and adapter 900 may be a component that utilizes specific cloud adapters or web crawlers or adapters to read pages (e.g., with different page types). The cloud adapters are built for different clouds, including but not limited to, a commerce cloud, a marketing cloud, a sales cloud, and/or a service cloud. In some aspects, the cloud adapters may be specialized crawlers that have authentication routines for different enterprise accounts among enterprise specific processing. In some aspects, generic web crawlers may also be used for other pages to load the page data in a specific format for any subsequent processing by SEO elevate processing engine 300.

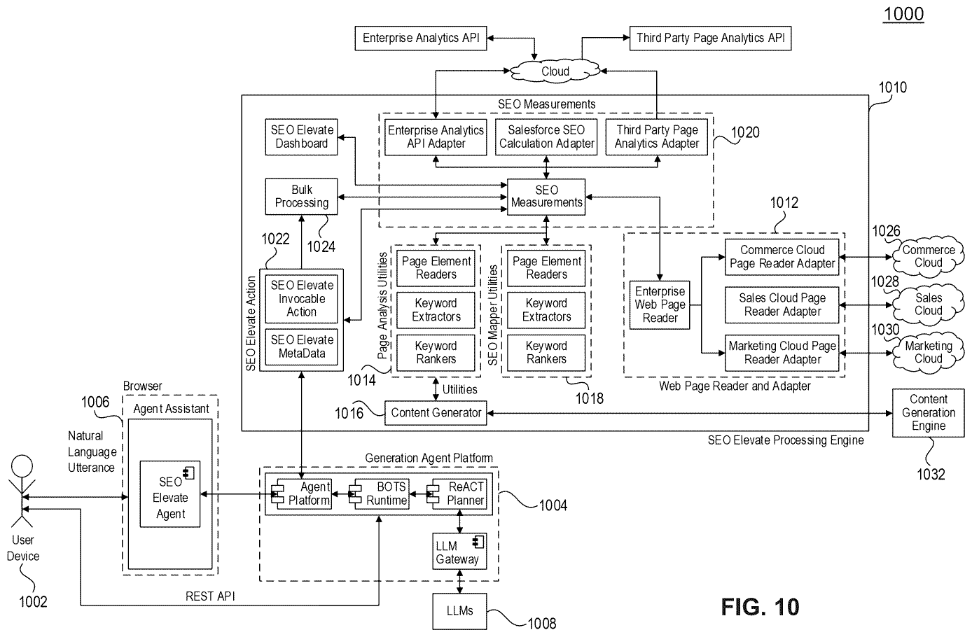

FIG. 10 is a block diagram illustrating an operational framework 1000 of a SEO elevate system 100, according to aspects of the present disclosure. FIG. 10 shall be described as an embodiment of FIG. 1. However, operational framework 1000 is not limited to that embodiment. In some aspects, operational framework 1000 may include multiple phrases, including but not limited to, user requirement capture, page loading and adaption, page content analysis, content generation (e.g., refinement), SEO attribute mapping, and/or SEO score measurement.

User requirement capture may refer to a phase in which a user device 1002 (e.g., a page admin) issues a natural language utterance expressing at least a desire to extract the SEO score for a page or a desire to fix the SEO score of a page. User device 1002 may issue the natural utterance expressing the desires based on a REST API request. After receiving the user request, a generation agent platform 1004 may analyze the natural utterance prompt and/or coordinate various agents based on the user prompt.

In some aspects, generation agent platform 1004 may be configured to interface with an agent assistant 1006 (e.g., a browser for user device 1002) to open a remote takeover session on the endpoint or execute tasks on the session. Agent assistant 1006, based on the session, may allow generation agent platform 1004 to connect to more than one user device at the same time. In some aspects, generation agent platform 1004 can also query an LLM 1008 (e.g., via an LLM gateway) to perform any tasks related to perform tasks that require at least sequential reasoning, planning, and/or potentially, memory. These tasks may be designed to move beyond LLM responses by incorporating elements, including but not limited to, task decomposition, tool usage, and/or collaboration with other agents.

After capturing and analyzing the user requirement, the request or prompt from user device 1002 may be routed to a SEO elevate processing engine 1010. SEO elevate processing engine 1010 may include, but is not limited to, a web page reader and adapter 1012, a page analysis utility 1014, a content generator 1016, a SEO mapper utility 1018, and/or a SEO score measurement 1020. In some aspects, the request from user device 1002 may be routed to a SEO elevate action 1022, which in turn may delegate the request to a bulk processing 1024 to invoke for batch runs on multiple pages. SEO score measurement 1020 may then be activated to handle bulk processing requests. In some aspects, SEO score measurement 1020 may also orchestrate other requests, including but not limited to, invoking a SEO measurement adapter to get score of existing page, invoking the web page reader and adapter to extract web page content, invoking page analysis utility 1014 to evolve brand specific enriched text, invoking SEO mapper utility 1018 to determine how enriched the text keywords are, invoking content generator 1016 to create content for SEO elevation, and/or updating the page based on the created content.

Page loading and adaption may refer to a phase in which web page reader and adapter 1012 may be activated or orchestrated to utilize cloud adapters or web crawlers to read or adapt pages in a specific format. The cloud adapters may be built for different clouds, such as commerce 1026, marketing 1030, sales 1028, and/or other service, etc. These cloud adapters may be specialized crawlers that have authentication routines for enterprise accounts among other enterprise specific processing.

Page content analysis may refer to a phase in which page analysis utility 1014 may analyze the content extracted by web page reader and adapter 1012 and subject the content to specific analysis about presence or absence of the certain sections within these web pages. The purpose of this phase may include, but is not limited to, analyzing the structure of the page with regards to its topic of business, navigability, consistent structure, and presence or absence of certain sections by search and SEO elevate processing engine 1010.

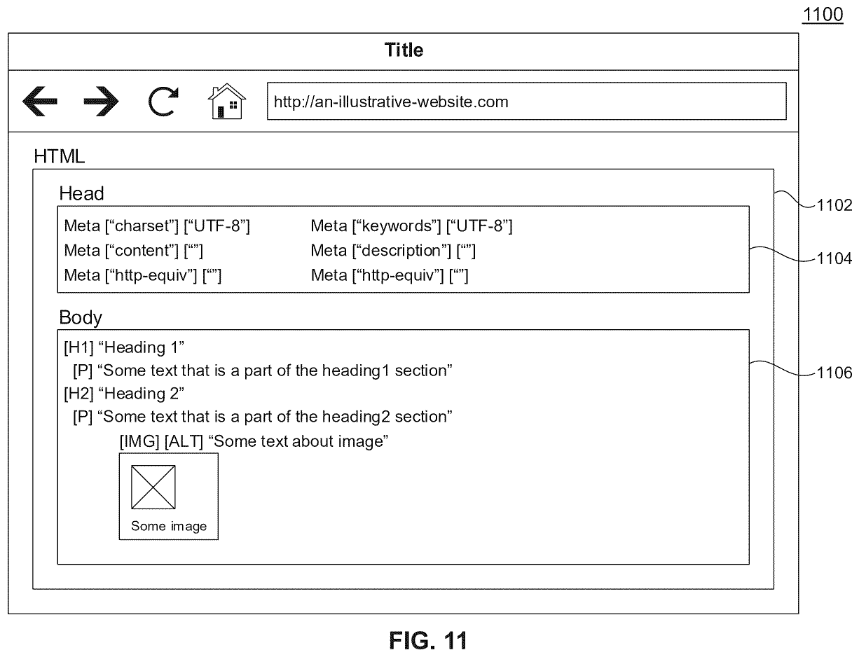

FIG. 11 illustrates a standard HTML page 1100, according to aspects of the present disclosure. As illustrated, a HTML page 1100 may include, but is not limited to, different sections such as HTML 1102, head section 1104, body section 1106, etc. Each of the sections may have their respective purposes and importance.

In some aspects, the key sections of a HTML page 1100 may include, but are not limited to, a <!DOCTYPE html> Declaration section, a <html> Element section, a <head> section, and/or a <body> section. For example, the <!DOCTYPE html> Declaration section may refer to the document type declaration, specifying the version of HTML being used. The <html> Element section may refer to a root element that wraps the content on the page in which this section may often include a Lang attribute to define the document's primary language. The <head> section may include metadata about the page, such as <title>, <meta>, and/or links to external stylesheets or scripts. The <title> may be used to set the page title visible in browser tabs and the <meta> may be used to provide information like character encoding (charset=“UTF-8”) and viewport settings for responsive design. The <body> section may hold visible contents of the page, including but not limited to, headings (e.g., <h1> to <h6>) for titles and subheadings, paragraphs (e.g., <p>) for images, links, tables, etc., and semantic elements like <header>, <footer>, <main>, <section>, and <article> for better structure and accessibility. These sections of may ensure a clear organization and functionality for web pages.

In some aspects, there are some sections (e.g., business sections) of an HTML page 1100 which may convey some information of use with reference to the topic of the page. The business sections may provide detailed information about their business product, ideas, services etc. For example, these business sections may be within body section 1106 outlined in HTML 1102. Further there may be some sections of HTML page 1100 (e.g., SEO interest sections), which are of importance to the SEO and search engines. These sections may include some sections in the head section of the page as well as some sections within the body section of the page.

For example, the SEO interest sections may include, but are not limited to, title tags (e.g., <title>), meta descriptions (e.g., <meta name=“description”>), header tags (e.g., <h1> to <h6>), image alt text (e.g., alt), and/or other structured data. The title tags may define the page's name and appear in search engine results and browser tabs. The title tags may also include relevant keywords and provide a concise summary of the page content. The meta descriptions may appear below the title in search results in which the meta descriptions with keywords can improve click-through rates by enticing users to visit the webpage. The header tags structure content hierarchically, helping search engines understand the page's main topics and subtopics. For example, the <h1> tag is critical as it represents the primary headline, while <h2> and beyond organize subheadings. The image alt attributes may describe images for search engines, making them accessible and improving visibility in image-based searches. The structure data may use schema markup to help search engines interpret content more effectively, enabling features, including but not limited to, rich snippets and/or featured snippets on search results pages. In some aspects, by optimizing these sections above, the websites or pages can enhance visibility and user engagement.

Referring back to FIG. 10, content generation and/or refinement may be a phase in which a content generator 1016 may generate brand specific text for a certain section of the page, for example product description or business section for a product page. Once the content is generated, content generator 1016 may also create a list of top keywords that can be used to enrich information in sections for a SEO boost. In some aspects, the list of top N keywords (e.g., N is a configurable parameter) may be extracted from the generated content in the business sections after eliminating the stop words. Content generator 1016 may generate content can also cover multiple output formats or modalities, including but not limited to, text, image, video and/or audio. In some aspects, content generator 1016 may invoke or query a content generation engine 1032 (e.g., an agentic or LLM-based system) to create content of a suitable word count for any text generation tasks. The generated content may then be rephrased or tuned according to the branding guidelines of the enterprise. To rephrase the generated content, content generator 1016 may be configured to refine the created content to align with specific branding guidelines. During the brand tuning, content generator 1016 can define how the content generation agent behaves, what resources (e.g., brand guidelines or any other contexts) it uses, and how it interacts with its environment, to ensure that generated content align with specific brand guidelines.

In some aspects, after the content is generated, the content may be subject to a content approval flow. This content approval flow may involve a collaboration between multiple functional groups or departments of the enterprise in the decision making about an external facing content. The content approval flow may support a manual mode and automated mode. All changes made during this content approval process may be maintained as a matter of audit. In some aspects, in the manual mode, the content approval may be done via emails and managed by one or more approvers. A central person or user device may be responsible for consolidating any changes and making sure that the suggestions are incorporated. In the manual mode, the user may mark approval entries for generated content via a user utterance, such as “Mark the content <<content identifier>> with approval from <<name>> and email <<<Email>>.” In some aspects, in the automated mode, an automated approval flow for generated content may be triggered via a pre-configured approval chain. This automated approval flow may also be subject to certain rules that may be triggered to ensure that the approval of approvers can be sought.

In some aspects, after the content is generated and approved, the content may further be subject to an infringement check. The infringement check of the content may be based on one or more plagiarism detection algorithms or systems to prevent plagiarism in assignments and test. For example, a text matching may be applied by the plagiarism detection algorithms or systems between the content and a database of copyrighted content to detect any potential infringements. The plagiarism detection algorithms or systems may rely on fingerprinting hashes (e.g., a unique identifier) of document or content in which the fingerprint may allow the plagiarism detection algorithms or systems to search for it online and identify potential copies or unauthorized uses, even if the document or content has been edited or altered. The plagiarism detection algorithms or systems may also perform citation analysis in assessing the potential for infringement in a video or a document (e.g., a patent). For example, the citation analysis may involve examining how often a patent has been cited by other patents and publications, which can indicate the importance of the patent in its field and the potential for others to be infringing on it. A high number of forward citations suggests a patent is influential and likely to be used by others, potentially leading to infringement. NLP semantic match and cross-language plagiarism detection may be used by the plagiarism detection algorithms or systems for the content-based infringement check to determine if two elements (e.g., a word, phrase, sentence, document, or even a corpus) have the same meaning.

In some aspects, after content is generated in the appropriate output format (e.g., text, image, video, and sound), the content may need to be set in a layout (e.g., output template) that is best suited for the output channels. For the enterprise and desired output channel, the appropriate template may be retrieved from the configuration. This template may be populated with the necessary text. For the image, video, and audio content, appropriate links may be inserted along with the necessary thumbnails output channel transformation. In some aspects, a digital assistant may use channels, including but not limited to, live chat, SMS, email, and self-service portals to offer quick, convenient, and personalized interactions between generation agent platform 1004 and user device 1002.

SEO attribute mapping may refer to a phase in which SEO mapper utility 1018 may map or insert the content from business sections of the page to the SEO interest sections. SEO mapper utility 1018 may be configured to organize and optimize website content by assigning specific keywords to relevant pages. This keyword assignment may improve search engine visibility and ensure that the right pages appear for or target the right search queries. In some aspects, SEO mapper utility 1018 may help identify relevant keywords and analyze their search volume, competition, and trends. SEO mapper utility 1018 may also create a keyword map for website structure and content in which the pages and keywords can be arranged in groups of keyword clusters to create a logical structure of the website based on the keywords. In some aspects, SEO mapper utility 1018 may pick and then insert the keywords that should be copied over to the SEO interest sections (e.g., until the maximum length limit for the sections is reached).

SEO score measurement 1020 may refer to a phase in which SEO score measurement 1020 may generate SEO scores using different engines. This phase may measure the SEO score and convey the information to the user device of this tooling. Once the SEO measurement routines are run, the analysis of the page (e.g., performed by the analysis utility) may be available in terms of the actions to take the overall SEO score of the page. In some aspects, SEO score measurement 1020 can analyze engagement metrics, including but not limited to, comments, shares, etc. to identify what content performs best and optimize future strategies. By monitoring or analyzing the engagement metrics, SEO score measurement 1020 can also identify relevant keywords and hashtags and then assign the keywords to different relevant pages (e.g., based on the SEO mapper utility) to improve content visibility and reach. In some aspects, SEO score measurement 1020 may also visualize key metrics, including but not limited to, rankings, traffic, and backlinks (e.g., based on the dashboard) to provide a comprehensive and real-time insight into the effectiveness of SEO strategies.

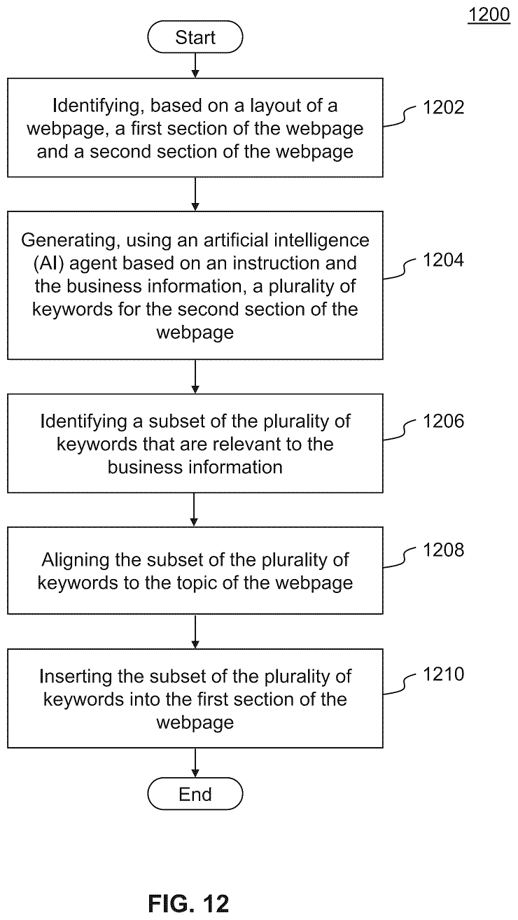

FIG. 12 is a flowchart illustrating a method 1200 for elevating a SEO score for a page, according to aspects of the present disclosure. Method 1200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 12, as will be understood by a person of ordinary skill in the art. Method 1200 shall be described with reference to FIGS. 1-10. However, method 1200 is not limited to those example aspects.

In 1202, a first section of the webpage and a second section of the webpage may be identified by SEO elevate system 100 based on a layout of the webpage. The first section, contributing to a SEO score associated with the webpage, may include but is not limited to, a metatag, an image alt source, and/or metadata that are not visible to a user device. The second section may include, but is not limited to, business information about a topic of the webpage. In some aspects, at least one of the first section of the webpage or the second section of the webpage may be real-time updated by SEO elevate system 100 based on at least one of content or a parameter provided by a user device.

In some aspects, to identify different sections of a webpage, SEO elevate system 100 may look for common elements, including but not limited to, the header, navigation bar (e.g., for quick access to other pages), sidebar (e.g., for additional content or navigation), main content area, footer (e.g., with contact information and links), and/or other key sections. In some aspects, SEO elevate system 100 may leverage at least AI or NLP technique to identify different sections of a webpage by analyzing the HTML structure and layout. For example, the AI or NLP system may identify a <header> tag in the HTML and use it to determine the header section. The AI or NLP system may identify a <nav> tag or a block of links that are visually presented as a navigation menu. The AI or NLP system may also identify a <main> tag or a block of content that visually occupies the central area of the page. The AI or NLP system may identify a <footer> tag or a section at the bottom of the page containing copyright information and links.

In 1204, a plurality of keywords for the second section of the webpage may be generated by SEO elevate system 100 using an AI agent based on an instruction and the business information. The instruction may include, but is not limited to, a goal for the AI agent and an action to be performed by the AI agent in order to achieve the goal in which the goal may be associated with the business information. In some aspects, the plurality of keywords may further include, but is not limited to, a plurality of stop words and another subset of the plurality of keywords relevant to the business information but not aligning to the topic of the webpage.

In 1206, a subset of the plurality of keywords that are relevant to the business information may be identified by SEO elevate system 100. This subset identification may be used in by SEO elevate system 100 in information retrieval, data analysis, and market research to focus on the most pertinent keywords. In some aspects, to extract a subset of the plurality of keywords, the SEO elevate system 100 may identify a subset of keywords that appears most frequently within the business information based on a frequency analysis. SEO elevate system 100 may perform a co-occurrence analysis to identify keywords that appear together as the subset. SEO elevate system 100 may also group keywords based on their meaning or relationships and then extract the keywords in the group as the subset of keywords for any further processing.

In 1208, the subset of the plurality of keywords may be aligned by SEO elevate system 100 to the topic of the webpage. The alignment of the subset of the plurality of keywords may include, but is not limited to, selecting a latent semantic indexing keywords (e.g., related terms that share semantic with the main keywords) to improve the SEO and visibility. In some aspects, this alignment may also continuously refine the keyword list and content to improve SEO and achieve goals of the enterprise.

In 1210, the subset of the plurality of keywords may be inserted by SEO elevate system 100 into the first section of the webpage. This insertion may include, but is not limited to, incorporating keywords into various areas of the webpage, including but not limited to, title tags, meta descriptions, headings, body text, and/or image alt text.

In some aspects, the SEO score associated with the webpage may be computed by SEO elevate system 100 and the computed SEO score associated with the webpage may be stored by into a database retrievable by a user device. A performance (e.g., a quantified low, medium, or high performance, etc.) of the webpage may additionally be determined by comparing the SEO score retrieved from the database to a pre-defined threshold. In some aspects, to compute the SEO score for a webpage, various SEO factors, including but not limited to, keyword relevance, backlink quality, site structure, mobile-friendliness, page speed, content quality, user experience, and/or technical SEO may be analyzed, ultimately providing a SEO score representing the page's adherence to the SEO practices. In some aspects, the various SEO factors may be weighted adaptively based on different business information or brand identities, and the weighted SEO factors may then be summarized to form the SEO score. In some aspects, to store the SEO score into the database, SEO elevate system 100 may create a table with columns for the webpage's uniform resource locator (URL) and the associated SEO score. SEO elevate system 100 may define the data types for each column.

In some aspects, an approval of the plurality of keywords may be received from a user device (e.g., as a user feedback) for the second section of the webpage. In some aspects, a plurality of webpages that are non-interactive to a user device may be determined by SEO elevate system 100 and the plurality of webpages may be processed using a batch mode to increase a plurality of SEO scores simultaneously. For example, batch processing may concurrently analyze at least a large number of website pages or an extensive list of keywords. Batch processing may also allow for the analysis of various SEO metrics in parallel, including but not limited to, keyword rankings, backlink profiles, on-page optimization, and technical SEO health to identify areas for improvement and provide insights into overall SEO performance.

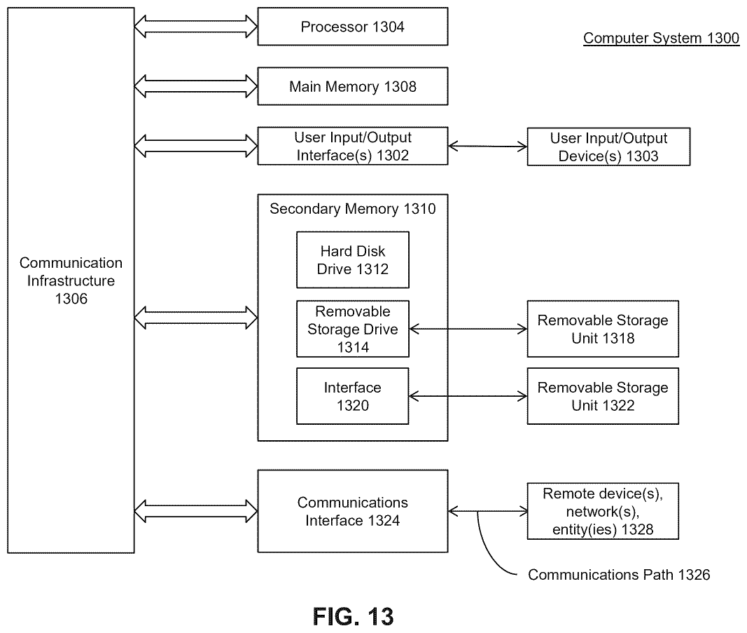

Various aspects may be implemented, for example, using one or more well-known computer systems, such as computer system 1300 shown in FIG. 13. For example, aspects herein using SEO elevate system 100 may be implemented using combinations or sub-combinations of computer system 1300. Also or alternatively, one or more computer systems 1300 may be used, for example, to implement any of the aspects discussed herein, as well as combinations and sub-combinations thereof. A “module,” as the term is used herein, is a computational element that performs one or more functions according to computer readable instructions stored on one or more memories or other non-transitory computer-readable media.

Computer system 1300 may include one or more processors (also called central processing units, or CPUs), such as a processor 1304. Processor 1304 may be connected to a communication infrastructure or bus 1306.

Computer system 1300 may also include user input/output device(s) 1303, such as monitors, keyboards, pointing devices, etc., which may communicate with communication infrastructure 1306 through user input/output interface(s) 1302.

One or more of processors 1304 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1300 may also include a main or primary memory 1308, such as random access memory (RAM). Main memory 1308 may include one or more levels of cache. Main memory 1308 may have stored therein control logic (i.e., computer software) and/or data.

Computer system 1300 may also include one or more secondary storage devices or memory 1310. Secondary memory 1310 may include, for example, a hard disk drive 1312 and/or a removable storage device or drive 1314. Removable storage drive 1314 may be a floppy disk drive, a magnetic tape drive, a compact disk drive, an optical storage device, tape backup device, and/or any other storage device/drive.

Removable storage drive 1314 may interact with a removable storage unit 1318. Removable storage unit 1318 may include a computer usable or readable storage device having stored thereon computer software (control logic) and/or data. Removable storage unit 1318 may be a floppy disk, magnetic tape, compact disk, DVD, optical storage disk, and/any other computer data storage device. Removable storage drive 1314 may read from and/or write to removable storage unit 1318.

Secondary memory 1310 may include other means, devices, components, instrumentalities or other approaches for allowing computer programs and/or other instructions and/or data to be accessed by computer system 1300. Such means, devices, components, instrumentalities or other approaches may include, for example, a removable storage unit 1322 and an interface 1320. Examples of the removable storage unit 1322 and the interface 1320 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1300 may further include a communication or network interface 1324. Communication interface 1324 may enable computer system 1300 to communicate and interact with any combination of external devices, external networks, external entities, etc. (individually and collectively referenced by reference number 1328). For example, communication interface 1324 may allow computer system 1300 to communicate with external or remote devices 1328 over communications path 1326, which may be wired and/or wireless (or a combination thereof), and which may include any combination of LANs, WANs, the Internet, etc. Control logic and/or data may be transmitted to and from computer system 1300 via communication path 1326.

Computer system 1300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1300, main memory 1308, secondary memory 1310, and removable storage units 1318 and 1322, as well as tangible articles of manufacture embodying any combination of the foregoing. Such control logic, when executed by one or more data processing devices (such as computer system 1300 or processor(s) 1304), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 13. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

1. A method using one or more processors, comprising:
identifying, based on a layout of a webpage, a first section of the webpage and a second section of the webpage, the first section contributing to a search engine optimization (SEO) score associated with the webpage, the second section comprising business information about a topic of the webpage;
generating, using an artificial intelligence (AI) agent based on an instruction and the business information, a plurality of keywords for the second section of the webpage, wherein the instruction comprises:
a goal for the AI agent, the goal being associated with the business information; and
an action to be performed by the AI agent in order to achieve the goal, wherein the instruction is generated based on identification of characteristics of one or more additional top-ranking webpages associated with the topic of the webpage, the action being defined to incorporate the identified characteristics into generation of the plurality of keywords;
identifying a subset of the plurality of keywords that are relevant to the business information;
aligning the subset of the plurality of keywords to the topic of the webpage; and
inserting the subset of the plurality of keywords into the first section of the webpage.

2. The method according to claim 1, wherein the first section comprises a metatag, an image alt source, and metadata that are not visible to a user device.

3. The method according to claim 1, wherein the plurality of keywords further comprise a plurality of stop words and another subset of the plurality of keywords relevant to the business information but not aligning to the topic of the webpage.

4. The method according to claim 1, further comprising:
computing the SEO score associated with the webpage;
storing the SEO score associated with the webpage into a database retrievable by a user device; and
determining a performance of the webpage by comparing the SEO score retrieved from the database to a pre-defined threshold.

5. The method according to claim 1, wherein at least one of the first section of the webpage or the second section of the webpage is real-time updated based on at least one of content or a parameter provided by a user device.

6. The method according to claim 1, further comprising receiving, from a user device, an approval of the plurality of keywords for the second section of the webpage.

7. The method according to claim 1, further comprising:
determining a plurality of webpages are non-interactive to a user device; and
in response to the determining, processing, using a batch mode, the plurality of webpages to increase a plurality of SEO scores simultaneously.

8. A system, comprising:
a memory configured to store operations; and
one or more processors configured to perform the operations, the operations comprising:
identifying, based on a layout of a webpage, a first section of the webpage and a second section of the webpage, the first section contributing to a search engine optimization (SEO) score associated with the webpage, the second section comprising business information about a topic of the webpage;
generating, using an artificial intelligence (AI) agent based on an instruction and the business information, a plurality of keywords for the second section of the webpage, wherein the instruction comprises:
a goal for the AI agent, the goal being associated with the business information; and
an action to be performed by the AI agent in order to achieve the goal. wherein the instruction is generated based on identification of characteristics of one or more additional top-ranking webpages associated with the topic of the webpage. the action being defined to incorporate the identified characteristics into generation of the plurality of keywords;
identifying a subset of the plurality of keywords that are relevant to the business information;
aligning the subset of the plurality of keywords to the topic of the webpage; and
inserting the subset of the plurality of keywords into the first section of the webpage.

9. The system according to claim 8, wherein the first section comprises a metatag, an image alt source, and metadata that are not visible to a user device.

10. The system according to claim 8, wherein the plurality of keywords further comprise a plurality of stop words and another subset of the plurality of keywords relevant to the business information but not aligning to the topic of the webpage.

11. The system according to claim 8, the operations further comprising:
computing the SEO score associated with the webpage;
storing the SEO score associated with the webpage into a database retrievable by a user device; and
determining a performance of the webpage by comparing the SEO score retrieved from the database to a pre-defined threshold.

12. The system according to claim 8, wherein at least one of the first section of the webpage or the second section of the webpage is real-time updated based on at least one of content or a parameter provided by a user device.

13. The system according to claim 8, the operations further comprising:
receiving, from a user device, an approval of the plurality of keywords for the second section of the webpage.

14. The system according to claim 8, the operations further comprising:
determining a plurality of webpages are non-interactive to a user device; and
in response to the determining, processing, using a batch mode, the plurality of webpages to increase a plurality of SEO scores simultaneously.

15. A non-transitory computer-readable storage device having instructions stored thereon, execution of which, by one or more processing devices, causes one or more processors to perform operations comprising:
identifying, based on a layout of a webpage, a first section of the webpage and a second section of the webpage, the first section contributing to a search engine optimization (SEO) score associated with the webpage, the second section comprising business information about a topic of the webpage;
generating, using an artificial intelligence (AI) agent based on an instruction and the business information, a plurality of keywords for the second section of the webpage, wherein the instruction comprises:
a goal for the AI agent, the goal being associated with the business information; and
an action to be performed by the AI agent in order to achieve the goal, wherein the instruction is generated based on identification of characteristics of one or more additional top-ranking webpages associated with the topic of the webpage, the action being defined to incorporate the identified characteristics into generation of the plurality of keywords;
identifying a subset of the plurality of keywords that are relevant to the business information;
aligning the subset of the plurality of keywords to the topic of the webpage; and
inserting the subset of the plurality of keywords into the first section of the webpage.

16. The non-transitory computer-readable storage device according to claim 15, wherein the first section comprises a metatag, an image alt source, and metadata that are not visible to a user device.

17. The non-transitory computer-readable storage device according to claim 15, wherein the plurality of keywords further comprise a plurality of stop words and another subset of the plurality of keywords relevant to the business information but not aligning to the topic of the webpage.

18. The non-transitory computer-readable storage device according to claim 15, the operations further comprising:
computing the SEO score associated with the webpage;
storing the SEO score associated with the webpage into a database retrievable by a user device; and
determining a performance of the webpage by comparing the SEO score retrieved from the database to a pre-defined threshold.

19. The non-transitory computer-readable storage device according to claim 15, wherein at least one of the first section of the webpage or the second section of the webpage is real-time updated based on at least one of content or a parameter provided by a user device.

20. The non-transitory computer-readable storage device according to claim 15, the operations further comprising:
determining a plurality of webpages are non-interactive to a user device; and
in response to the determining, processing, using a batch mode, the plurality of webpages to increase a plurality of SEO scores simultaneously.
